(19) United States
(12) Patent Application Publication
(10) Pub. No.: US 2022/0362592 A1
(43) Pub. Date: Nov. 17, 2022

(54) SYSTEM AND METHOD FOR LOWERING A USER FROM AN ELEVATED POSITION

(71) Applicant: BRITISH COLUMBIA FERRY SERVICES INC., Victoria (CA)

(72) Inventors: Robert Clark, Sidney (CA); Andrew Higginson, Cobble Hill (CA); David Gymer, Sooke (CA); David Fagen, Victoria (CA)

(21) Appl. No.: 17/753,260

(22) PCT Filed: Aug. 26, 2019
(86) PCT No.: PCT/CA2019/051169

§ 371 Date: Feb. 25, 2022

(51) Int. Cl. A62B 35/00; A62B 1/08; B63C 9/26

(52) U.S. Cl. CPC A62B 35/0037; A62B 1/08; A62B 35/0093; B63C 9/26

(57) ABSTRACT

A system for lowering a user from an elevated position is described. The system includes a fall-arresting device operable to arrest a fall of a user attached to the fall-arresting device, a harness for wearing by the user, and a separable connector for attaching the harness to the fall-arresting device. The separable connector is configured to separate in response to a minimum load of about 0.66 kN acting on the separable connector and thereby disconnect the harness from the fall-arresting device.

### FIELD OF THE DISCLOSURE

The present disclosure relates to systems and methods for lowering a user from an elevated position, for example from a deck of a marine vessel.

### BACKGROUND TO THE DISCLOSURE

A number of maritime regulatory bodies require that, in order to maintain operational competence, personnel regularly launch and recover rescue boats. During these drills, crewmembers in a rescue boat are lowered and raised from a marine vessel's deck to the water. Typically, the rescue boat is attached via a four-point bridle to a single davit line. Launch heights may range, for example, from 40 to 70 feet or more.

In the past, such drills have resulted in numerous injuries and fatalities every year. For example, in two particular cases, during a routine drill, the davit line separated, causing the rescue boat to fall about forty feet to the water below. One of the two occupants of the rescue boat landed on the rescue boat, resulting in catastrophic injury. The second occupant made partial contact with the rescue boat, resulting in serious but non-life threatening injury.

With this background in mind, the present disclosure describes systems and methods for more safely lowering users, such as mariners, from elevated positions, such as from the decks of marine vessels.

### SUMMARY OF THE DISCLOSURE

According to a first aspect of the disclosure, there is provided a system for lowering a user from an elevated position, comprising: a fall-arresting device operable to arrest a fall of a user attached to the fall-arresting device; a harness for wearing by the user; and a separable connector for attaching the harness to the fall-arresting device, wherein the separable connector is configured to separate in response to a minimum load of about 0.66 kN acting on the separable connector and thereby disconnect the harness from the fall-arresting device.

The fall-arresting device may comprise: a housing; a safety line for withdrawing from the housing and for attaching to the user; and a brake operable to prevent further withdrawal of the safety line from the housing in response to a rate of withdrawal of the safety line from the housing exceeding a predetermined threshold.

The fall-arresting device may comprise a controlled descent device operable to controllably lower the user from an elevated position in response to a weight of the user acting on the controlled descent device.

The controlled descent device may comprise an auto-belay device.

The separable connector may comprise two or more releasably connected members.

The two or more releasably connected members may be releasably connected using hook-and-loop fasteners.

The separable connector may comprise a release member for separating the separable connector in response to the user operating the release member.

The release member may comprise a loop of material extending from at least one of the releasably connected members.

The harness may be a full-body harness.

The harness may comprise an attachment point for securing the harness to the separable connector. The attachment point may be located on the harness such that, when the harness is worn by the user, the attachment point is located above a waist of the user.

The minimum load may be about 1 kN, or about 1.5 kN, or about 2 kN, or about 2.5 kN.

The system may further comprise a tool for cutting the separable connector by the user. The separable connector may be configured to break in response to the minimum load acting on the separable connector and thereby disconnect the harness from the fall-arresting device.

The separable connector may comprise one or more elements for protecting the separable connector from UV radiation.

According to a further aspect of the disclosure, there is provided a method of lowering a user from an elevated position, comprising: lowering, from an elevated position, a user attached to a fall-arresting device operable to arrest a fall of the user, wherein the user is secured via a harness to a separable connector attached to the fall-arresting device, and wherein the separable connector is configured to separate in response to a load greater than a weight of the user acting on the separable connector and thereby disconnect the harness from the fall-arresting device.

The fall-arresting device may comprise: a housing; and a safety line attached to the user. The safety line may be gradually withdrawn from the housing as the user is lowered from the elevated position, and the fall-arresting device may further comprise a brake operable to prevent further withdrawal of the safety line from the housing in response to a rate of withdrawal of the safety line from the housing exceeding a predetermined threshold.

The elevated position may be a deck of a marine vessel.

The lowering may comprise lowering a launcheable watercraft, in which is located the user, from a deck of a marine vessel.

The lowering may comprise lowering the launcheable watercraft using a davit of the marine vessel, and the fall-arresting device may be secured to the davit.

The method may further comprise arresting, with the fall-arresting device, a fall of the user in response to the launcheable watercraft falling during the lowering of the launcheable watercraft.

The method may further comprise separating the separable connector and thereby disconnecting the harness from the fall-arresting device in response to a weight of the launcheable watercraft at least partially acting on the separable connector during the falling of the launcheable watercraft.

The fall-arresting device may comprise a controlled descent device operable to controllably lower the user in response to a weight of the user acting on the controlled descent device.

The controlled descent device may comprise an auto-belay device.

The separable connector may comprise two or more releasably connected members.

The two or more releasably connected members may be releasably connected using hook-and-loop fasteners.

The separable connector may comprise a release member for separating the separable connector in response to the user operating the release member.

The release member may comprise a loop of material extending from at least one of the releasably connected members.

The harness may be a full-body harness.

The harness may comprise an attachment point for securing the harness to the separable connector. The attachment point may be located on the harness such that, when the harness is worn by the user, the attachment point is located above a waist of the user.

The separable connector may be configured to break in response to the load greater than the weight of the user acting on the separable connector.

The separable connector may configured to separate in response to a load greater than about 110%, or about 150%, or about 200%, or about 300% of the weight of the user acting on the separable connector.

According to a further aspect of the disclosure, there is provided a marine vessel comprising the above-described system. The fall-arresting device may be secured to a davit of the marine vessel.

According to a further aspect of the disclosure, there is provided a separable connector for use in lowering a user from an elevated position, comprising: two or more releasably connected members; and a release member for separating the two or more releasably connected members in response to the user operating the release member, wherein the two or more releasably connected members are configured to separate in response to a minimum load of about 0.66 kN acting on at least one of the releasably connected members.

The two or more releasably connected members may be releasably connected using hook-and-loop fasteners.

The release member may comprise a loop of material extending from at least one of the releasably connected members.

The minimum load may be about 1 kN, or about 1.5 kN, or about 2 kN, or about 2.5 kN.

### BRIEF DESCRIPTION OF THE DRAWINGS

Embodiments of the disclosure will now be described in detail in conjunction with the accompanying drawings of which:

FIG. 1 shows a controlled descent system in accordance with embodiments of the disclosure;

FIG. 2 shows a davit anchor secured to a davit, in accordance with embodiments of the disclosure;

FIG. 3 shows an auto-belay device in accordance with embodiments of the disclosure;

FIGS. 4A and 4B show separate portions of a single separable connector, in accordance with embodiments of the disclosure;

FIG. 5 shows separable connectors in accordance with embodiments of the disclosure;

FIG. 6 shows a controlled descent system in use with a marine vessel, in accordance with embodiments of the disclosure; and

FIG. 7 shows a rescue boat and occupants being lowered to the waterline from a marine vessel, using a controlled descent system in accordance with embodiments of the disclosure.

### DETAILED DESCRIPTION OF EMBODIMENTS

The present disclosure seeks to provide improved systems and methods for lowering a user from an elevated position, and in particular for controlling a descent of the user from the elevated position. While various embodiments of the disclosure are described below, the disclosure is not limited to these embodiments, and variations of these embodiments may well fall within the scope of the disclosure which is to be limited only by the appended claims.

Generally, according to embodiments of the disclosure, there is described a controlled descent system for safely and controllably lowering a user, for example a mariner occupying a rescue boat or similar launcheable watercraft, from an elevated platform, for example from a deck of a marine vessel to the waterline. The system includes a controlled descent device, such as auto-belay device, attached to a separable connector. The separable connector is in turn attached to a harness worn or otherwise attached to the user. The separable connector is configured to separate in response to a minimum load acting on the separable connector and thereby disconnect the harness from the controlled descent device. Generally, the minimum load is greater than a weight of the user.

The process of lowering the user begins with the user located in the rescue boat that is to be lowered from the deck of the much larger marine vessel, such as a ship. The rescue boat is controllably lowered to the water below, using for example a davit anchored to the marine vessel's deck. Prior to and during the lowering, each occupant of the rescue boat is attached to an auto-belay device as described above. Each auto-belay device is itself secured to the davit.

Should the rescue boat suddenly fall to the waterline (for example, if the line connecting the rescue boat to the davit were to fail), then the auto-belay device arrests the user's fall and controllably and safely lowers the user to the water. In the event that the user, at the moment of failure of the davit line, becomes entangled with the rescue boat, then the sudden, substantial loading of the separable connector will cause to separable connector to separate or otherwise break, reducing the risk of injury or death to the user.

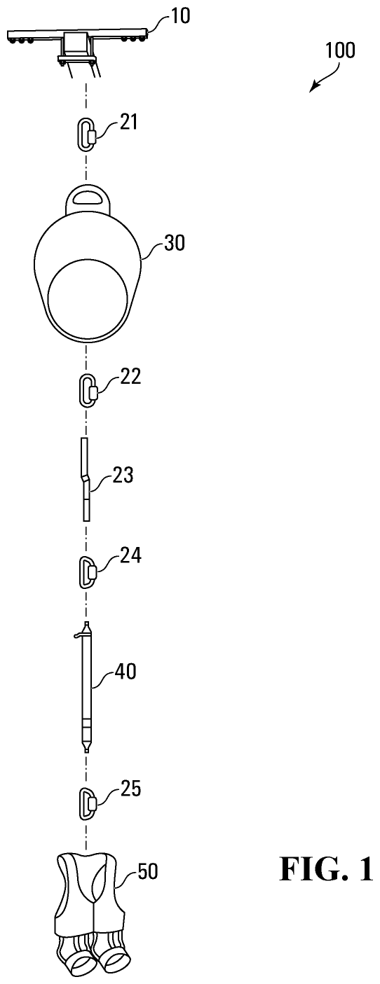

Turning to FIG. 1, there is shown a controlled descent system 100 for controlling a descent of a user, according to embodiments of the disclosure. Generally, controlled descent system 100 comprises a davit anchor 10, a controlled descent device 30, a separable connector 40, and a harness 50.

Davit anchor 10 may be secured to a large marine vessel, such as a ship. For instance, davit anchor 10 may be secured or otherwise anchored to a ship's davit or similar structure that is extendable over the side of the ship. Davit anchor 10 is connected to controlled descent device 30 via a connector 21, such as a carabiner or similar device.

Controlled descent device 30 may be, for example, any of various auto-belay devices. Controlled descent device 30 is connected to separable connector 40 via connectors 22 and 24, such as carabiners, and via a connecting strap 23. In particular, connecting strap 23 is connected to a safety line (e.g. webbing) that is payable out of/extendable out of controlled descent device 30, as described in further detail below. Connecting strap 23 enables a user to more easily connect separable connector 40 to the safety line of controlled descent device 30. Separable connector 40 is in turn connected to harness 50 via a connector 25, such as a carabiner.

While the various components of controlled descent system 100 have been described as being interconnected using various connectors 21, 22, and 24, and a connecting strap 23, davit anchor 10, controlled descent device 30, separable connector 40, and harness 50 may be interconnected using other means, according to some embodiments of the disclosure. In addition, the disclosure extends to greater or fewer components used to interconnect davit anchor 10, controlled descent device 30, separable connector 40, and harness 50. For example, according to some embodiments, controlled descent device 30 may be connected to separable connector 40 without the intermediary of connecting strap 23 and connector 24.

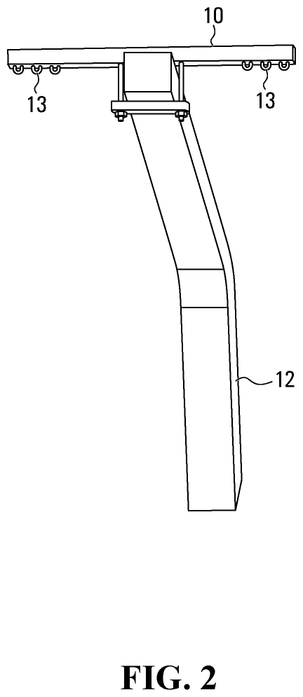

FIG. 2 shows davit anchor 10 in more detail. In particular, davit anchor 10 is secured to a davit 12 or similar structure anchored to a marine vessel. A vibration-dampening material is provided between davit anchor 10 and davit 12, and davit anchor 10 comprises a powder-coated finish for surface protection. Davit anchor 10 further includes multiple anchor points 13 to enable controlled descent device 30 to be secured to davit anchor 10 at multiple points, and/or to enable multiple controlled descent devices to be secured to davit anchor 10.

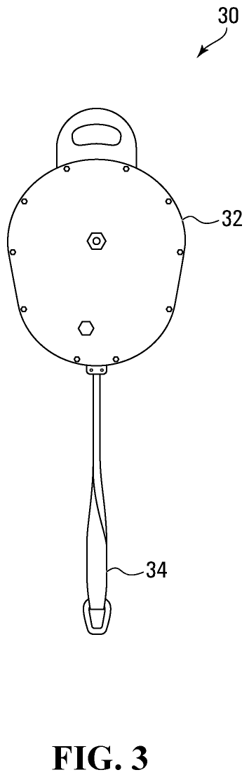

FIG. 3 shows controlled descent device 30 in more detail. According some embodiments, controlled descent device 30 is an auto-belay device. Auto-belay device 30 comprises a housing 32 enclosing a brake and a retracting mechanism (not shown), in addition to a connecting or safety line 34 extending out of and payable, or otherwise withdrawable, out of housing 32. Auto-belay device 30 enables a user attached to safety line 34, through the use of its brake, to be controllably lowered at a constant rate (for example 2 m/s) in response to safety line 34 being loaded with the user's weight. Without any load on safety line 34, the retracting mechanism is configured to exert an upward force on safety line 34, to retract safety line 34 within housing 32. According to some embodiments, auto-belay device 30 may be a Direct Drive Auto Belay manufactured by Perfect Descent Climbing Systems™, or a Trublue unit manufactured by Head Rush Technologies™.

The disclosure extends to other forms of controlled descent devices that are configured to control a descent of a user, by enabling the user to be lowered at a relatively safe rate. More generally, the disclosure extends to any fall-arresting device that is operable to arrest or otherwise stop a fall of a user. Thus, according to some embodiments, the disclosure extends to devices that do not necessarily lower a user in response to the device being loaded with the user's weight (for example in response to a fall), but merely prevent or arrest a user's fall in response to the device being loaded with the user's weight. Generally, such fall-arresting devices may include (similarly to auto-belay device 30) a housing, a safety line for paying out of or otherwise withdrawing from the housing and for attaching to the user, and a brake operable to prevent further withdrawal of the safety line from the housing in response to a rate of withdrawal of the safety line from the housing exceeding a predetermined threshold. Thus, such fall-arresting devices may prevent a user's fall using a brake that acts on the safety line in response to the rate of paying out, or withdrawal, of the safety line from the housing exceeding a predetermined limit.

Accordingly, throughout this disclosure, a fall-arresting device should be interpreted broadly as meaning any device operable to arrest a fall of a user. Throughout this disclosure, a fall-arresting device should furthermore be held to include any controlled descent device, i.e. a device that not only arrests a user's uncontrolled rate of descent due to a fall but, thereafter, safely lowers the user at a controlled rate of descent. Furthermore, in the context of this disclosure, arresting a fall should be interpreted broadly so as to include reducing the rate of descent of an uncontrolled fall to a relatively slower and controlled rate of descent. Thus, a controlled descent device acts to both arrest a user's fall (either by completely halting a user's fall, or else substantially decreasing a user's rate of fall) and subsequently lower them at a controlled rate of descent.

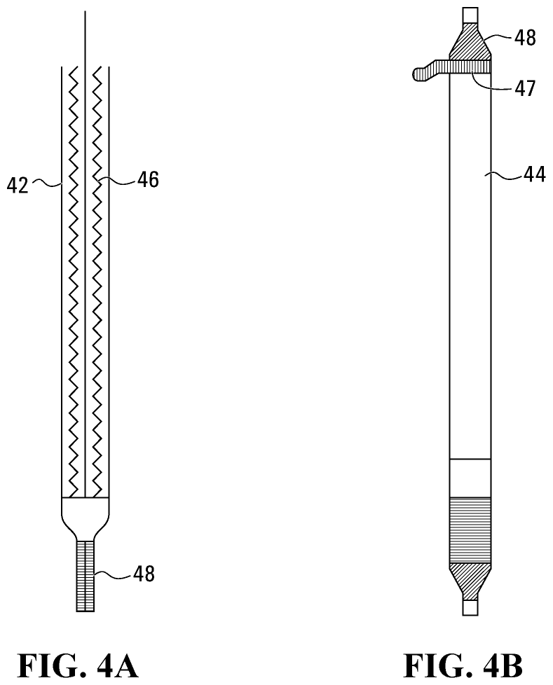

FIGS. 4A and 4B show, respectively, a first side of a first releasable member 42, and a second side of a second releasable member 44. Together, releasable members 42 and 44 form separable connector 40. Releasable members 42 and 44 are joined together using releasable means, such as hook and loop fasteners 46 (such as Velcro®). Other means of releasably joining members 42 and 44 may be used, such as stitching designed to fail under a predetermined minimum load. The stitching may be sheathed in plastic for protection. Alternatively, or in addition, means of releasably joining members 42 and 44 may include pins (such as metal, plastic, or composite pins) designed to fail under a predetermined minimum load, links (such as metal, plastic, textile, or composite links) designed to fail under a predetermined minimum load, or textiles with engineered weak points designed to rupture, break, or otherwise tear at the weak points under a predetermined minimum load.

Releasable members 42 and 44 include at ends thereof attachment points 48 for attaching to harness 50 and connecting strap 23. Stitching 47 across the top of releasable member 44 is designed to indicate partial deployment of separable connector 40 that would render it unfit for service. Stitching 47 is easily identifiable for pre-use inspection (for example, stitching 47 may be adjacent a highly visible tag, and stitching 47 itself may be red against a black background). Stitching 47 may be useful in confirming (or not) the integrity of the joining of releasable members 42 and 44 by hook and loop fasteners 46. For example, if stitching 47 is still intact, then a user may determine that releasable members 42 and 44 are properly interconnected by hook and loop fasteners 46. On the other hand, if stitching 47 is no longer intact, then the user may determine that releasable members 42 and 44 may be at least partially disconnected from one another.

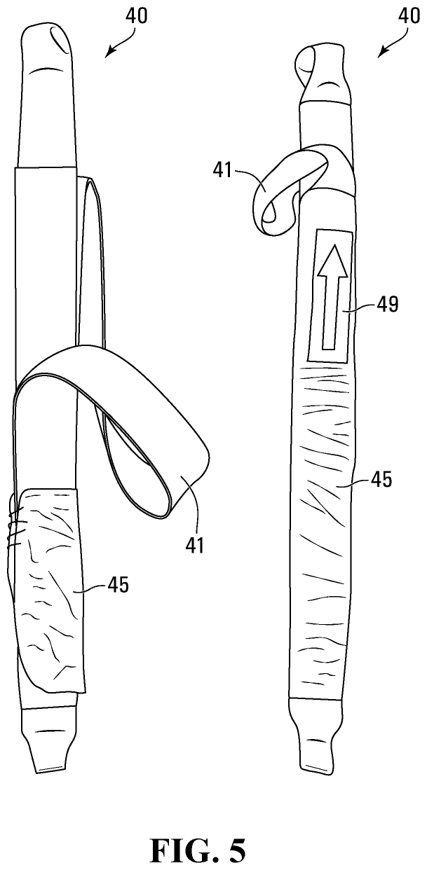

In addition, one or more of releasable members 42 and 44 may comprise one or more elements for protecting releasable members 42 and 44 from UV-based degradation. For example, separable connector 40 may include a UV-resistant stitched sheath 45 (seen in FIG. 5).

Separable connector 40 further includes an outer reflective material (such as a high-visibility fabric) in order to facilitate confirmation by crewmembers that separable connector 40 is in use. Furthermore, when multiple crewmembers are being attached to multiple separable connectors 40, each separable connector 40 may be color-coded to ensure that each crewmember attaches themselves to the correct separable connector. For example, a crewmember in the bow of the launcheable watercraft may need to connect themselves to a particular controlled descent device 30 and associated separable connector 40, based on the relative position of the controlled descent device 30 anchored to davit 12.

Releasable members 42 and 44 are sufficiently strong to support the weight of a user. For example, according to some embodiments, releasable members 42 and 44 are configured to support a weight of up to about 270 pounds. The bonding or joining strength of releasable member 42 to releasable member 44 is configured such that a predetermined minimum load will cause releasable members 42 and 44 to separate from one another. For example, according to some embodiments, releasable members 42 and 44 will separate in response to a load of at least 1 kN, or at least 1.5 kN, or at least 2 kN, or at least 2.5 kN. According to some embodiments, for example for particularly light crewmembers, releasable members 42 and 44 will separate in response to a load of at least 0.66 kN. According to some embodiments, releasable members 42 and 44 are configured to release as a function of a weight of the user. For example, releasable members 42 and 44 may separate in response to a load of at least 110%, 150%, 200%, or 300% of the weight of the user.

According to some embodiments, instead of using two or more members releasably joined to one another, separable connector 40 may comprise a single unitary piece of material that may be configured to break in response to the predetermined minimum load. However, unlike releasable members 42 and 44, such separable connectors would not be reusable.

FIG. 5 shows two separable connectors 40 in greater detail. Separable connectors 40 include respective quick-release handles 41 that may be operated by the user. Quick-release handles 41 comprise loops of material extending from respective ones of releasable members 42 and 44. Operating a quick-release handle 41 will result in one of releasable members 42 and 44 being separated from the other releasable member. Separable connector 40 may include a position indicator 49 so that a crewmember will orient separable connector 40 right-side-up, depending on the configuration of quick-release handle 41.

Harness 50 may be any suitable harness for securing the user to separable connector 40. For example, harness 50 may be a full-body harness comprising a sternal D-ring connecting point. The sternal D-ring is positioned on harness 50 such that it is preferably above the crewmember's waistline and below the crewmember's scapula. Harness 50 may additionally be equipped with a cutting tool, such as a knife, for use by the user. Alternatively, the cutting tool may be stored on the user, such as on an inflatable vest worn by the user.

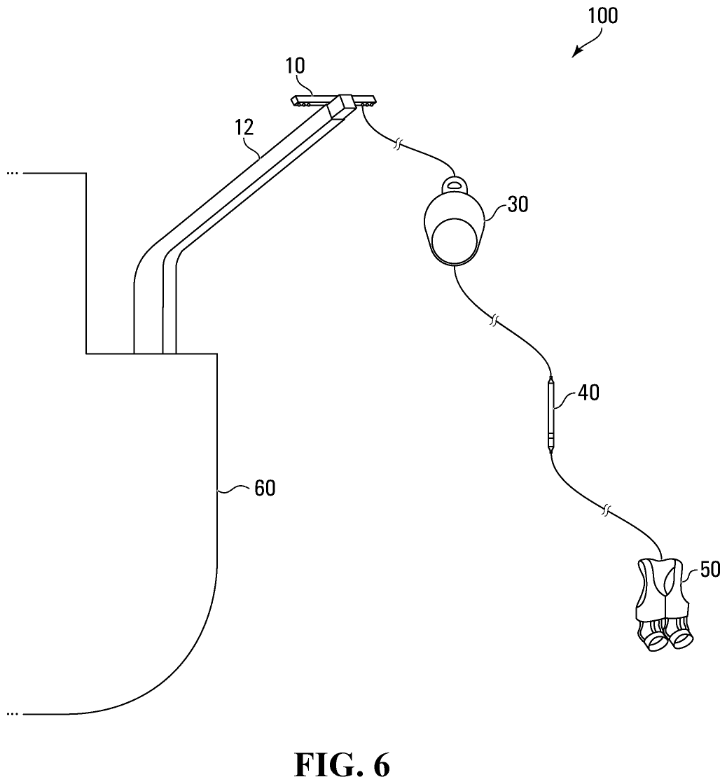

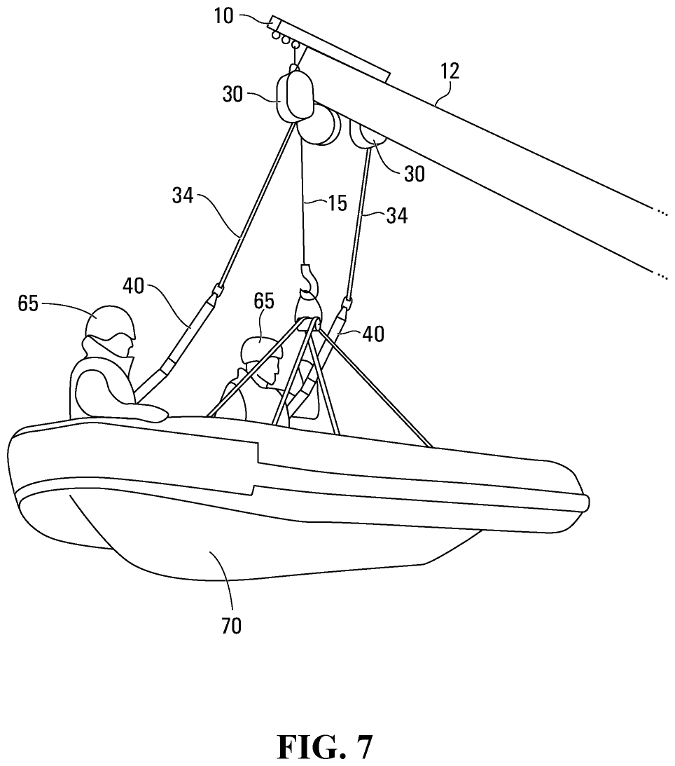

As can now be seen with reference to FIGS. 6 and 7, in use, controlled descent system 100 may be used to controllably and safely lower a user 65, such as a mariner, from an elevated position, such as from a deck of a marine vessel 60. In particular, user 65 may be controllably and safely lowered, together with a relatively smaller launcheable watercraft, such as an open rescue boat 70, to the waterline, as described below.

Rescue boat 70 is attached via a secure line 15 to a davit 12 onboard marine vessel 60. Prior to the lowering process, crewmembers 65 being lowered to the water are aboard rescue boat 70. Each crewmember 65 is attached to davit 12 using the above-described system. In particular, a crewmember 65 is secured to a separable connector 40 via a harness 50 worn by crewmember 65. Separable connector 40 is in turn attached to an auto-belay device 30. Auto-belay device 30 is anchored to davit 12 using davit anchor 10.

Rescue boat 70 is then lowered to the waterline using davit 12. Should secure line 15 fail for whatever reason, resulting in rescue boat 70 falling to the waterline, the resultant fall of crewmembers 65 is arrested by auto-belay devices 30, with separable connectors 40 being sufficiently strong to support the weights of crewmembers 65. After then being safely lowered to the water by auto-belay device 30, a crewmember 65 may manually disconnect themselves from davit 12 by actuating quick-release handle 41. Alternatively, crewmember 65 may cut through separable connector 40 using a cutting tool stored on their person or on harness 50. Still further, a cutting tool on the deck of marine vessel 60 may be used to disengage crewmember 65 from davit 12. While in the water, the position of the attachment point on harness 50 ensures that the force of secure line 15 pulls upwards on crewmember 65's body. Combined with a life jacket, crewmember 65's head should be kept up and out of the water if dragged.

If, at the moment that secure line 15 fails, a crewmember 65 should become entangled with rescue boat 70, then as described above separable connector 40 will separate or otherwise break apart in response to the very high load separable connector 40 is suddenly exposed to. In particular, the weight of rescue boat 70 is much greater than the minimum load at which separable connector 40 is configured to separate. As a result, crewmember 65 will fall to the water together with rescue boat 70. While this in itself may pose a danger to crewmember 65, the alternative of near-certain catastrophic injury or death is avoided.

While the systems and methods presented herein have been described in the particular context of lowering crewmembers from the deck of a marine vessel to the waterline, the systems and methods are not limited to such an application, and may be used in other applications, as will be recognized by the skilled person. In particular, the systems and methods described herein may be used in any suitable situation in which it is desired to safely lower a user from an elevated position. For example, the systems and methods described herein may be used in the context of any of various suitable industries, such as, but not limited to, high mast work (e.g. work on mobile device communication towers or the like), wind farms, roofing, the logging industry, crane assembly, and bridge construction.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

As used herein, a reference to “about” or “approximately” a number or to being “substantially” equal to a number means being within +/−10% of that number.

While the disclosure has been described in connection with specific embodiments, it is to be understood that the disclosure is not limited to these embodiments, and that alterations, modifications, and variations of these embodiments may be carried out by the skilled person without departing from the scope of the disclosure. It is furthermore contemplated that any part of any aspect or embodiment discussed in this specification can be implemented or combined with any part of any other aspect or embodiment discussed in this specification.

1. A system for lowering a user from an elevated position, comprising:
a fall-arresting device operable to arrest a fall of a user attached to the fall-arresting device;
a harness for wearing by the user; and
a separable connector for attaching the harness to the fall-arresting device, wherein the separable connector is configured to separate in response to a minimum load of about 0.66 kN acting on the separable connector and thereby disconnect the harness from the fall-arresting device.

2. The system of claim 1, wherein the fall-arresting device comprises:
a housing;
a safety line for withdrawing from the housing and for attaching to the user; and
a brake operable to prevent further withdrawal of the safety line from the housing in response to a rate of withdrawal of the safety line from the housing exceeding a predetermined threshold.

3. The system of claim 1, wherein the fall-arresting device comprises a controlled descent device operable to controllably lower the user from an elevated position in response to a weight of the user acting on the controlled descent device.

4. (canceled)

5. The system of claim 1, wherein the separable connector comprises two or more releasably connected members.

6. The system of claim 5, wherein the two or more releasably connected members are releasably connected using hook-and-loop fasteners.

7. The system of claim 1, wherein the separable connector comprises a release member for separating the separable connector in response to the user operating the release member.

8. The system of claim 7, wherein the release member comprises a loop of material extending from at least one of the releasably connected members.

9. (canceled)

10. The system of claim 1, wherein the harness comprises an attachment point for securing the harness to the separable connector, wherein the attachment point is located on the harness such that, when the harness is worn by the user, the attachment point is located above a waist of the user.

11. The system of claim 1, wherein the minimum load is about 1 kN.

12. (canceled)

13. (canceled)

14. (canceled)

15. The system of claim 1, further comprising a tool for cutting the separable connector by the user.

16. The system of claim 1, wherein the separable connector is configured to break in response to the minimum load acting on the separable connector and thereby disconnect the harness from the fall-arresting device.

17. The system of claim 1, wherein the separable connector comprises one or more elements for protecting the separable connector from UV radiation.

18. A method of lowering a user from an elevated position, comprising:
lowering, from an elevated position, a user attached to a fall-arresting device operable to arrest a fall of the user,
wherein the user is secured via a harness to a separable connector attached to the fall-arresting device, and
wherein the separable connector is configured to separate in response to a load greater than a weight of the user acting on the separable connector and thereby disconnect the harness from the fall-arresting device.

19. The method of claim 18, wherein the fall-arresting device comprises:
a housing; and
a safety line attached to the user,
wherein the safety line is gradually withdrawn from the housing as the user is lowered from the elevated position,
and wherein the fall-arresting device further comprises a brake operable to prevent further withdrawal of the safety line from the housing in response to a rate of withdrawal of the safety line from the housing exceeding a predetermined threshold.

20. (canceled)

21. The method of claim 18, wherein the lowering comprises lowering a launcheable watercraft, in which is located the user, from a deck of a marine vessel.

22. The method of claim 21, wherein the lowering comprises lowering the launcheable watercraft using a davit of the marine vessel, and wherein the fall-arresting device is secured to the davit.

23. The method of claim 21, further comprising:
arresting, with the fall-arresting device, a fall of the user in response to the launcheable watercraft falling during the lowering of the launcheable watercraft.

24. (canceled)

25. (canceled)

26. (canceled)

27. (canceled)

28. (canceled)

29. (canceled)

30. (canceled)

31. (canceled)

32. (canceled)

33. The method of claim 18, wherein the separable connector is configured to break in response to the load greater than the weight of the user acting on the separable connector.

34. The method of claim 18, wherein the separable connector is configured to separate in response to a load greater than about 110% of the weight of the user acting on the separable connector.

35. (canceled)

36. (canceled)

37. (canceled)

38. A marine vessel comprising a system for lowering a user from an elevated position, wherein the system comprises:
a fall-arresting device operable to arrest a fall of a user attached to the fall-arresting device;
a harness for wearing by the user; and
a separable connector for attaching the harness to the fall-arresting device, wherein the separable connector is configured to separate in response to a minimum load of about 0.66 kN acting on the separable connector and thereby disconnect the harness from the fall-arresting device.

39. (canceled)

40. (canceled)

41. (canceled)

42. (canceled)

43. (canceled)

44. (canceled)

45. (canceled)

46. (canceled)
